(19) United States
(12) Patent Application Publication
(10) Pub. No.: US 2011/0249956 A1
(43) Pub. Date: Oct. 13, 2011

(54) PROGRAM DATA PROCESSING DEVICE AND METHOD

(75) Inventor: Hiroyuki KOMAI, Kawasaki (JP)

(73) Assignee: FUJITSU LIMITED, Kawasaki (JP)

(21) Appl. No.: 13/163,130

(22) Filed: Jun. 17, 2011

Related U.S. Application Data
(63) Continuation of application No. PCT/JP2008/073694, filed on Dec. 26, 2008.

(51) Int. Cl. H04N 9/80

(52) U.S. Cl. 386/248; 386/E05.001

(57) ABSTRACT

A program data processing device includes a reading unit which reads a data part contained in program data from a file stored with program data, a feature extracting unit which extracts feature information for distinguishing between reproduction information to be reproduced from the data part and reproduction information to be reproduced from another data part, a weight acquiring unit which acquires a weight set on the extracted feature information from a weight table storage unit in which to set the weight per feature information contained in the program data and a weighting unit which allocates the acquired weight to the data part from which the feature portion is extracted.

### CROSS-REFERENCE TO RELATED APPLICATIONS

This is a continuation of Application PCT/JP2008/073694, filed on Dec. 26, 2008, now pending, the entire contents of which are incorporated herein by reference.

### FIELD

The present invention relates to a program data processing technology and a reproducing technology.

### BACKGROUND

Over the recent years, with acceleration of a multi-channel scheme in television broadcasting, there have been increased opportunities for viewing programs suited to preferences or tastes of users, and a conceivable number of programs desired for viewing by the users has been presumed to rise. It is, however, difficult for the users to view all of the preferential programs within a limited period of time. A spread of a technology is seen, which is contrived to view within the limited period of time by utilizing a variety of reproducing techniques.

This type of technology is exemplified by a highlight reproduction function of extracting only a scene (exciting scene) assumed to be a want-to-see scene of the user or a stretch reproduction function of adjusting a reproduction speed. The highlight reproduction function is to extract a highlight scene from within a video file and reproduce only the scene exhibiting a strong degree of highlight. This function is, in short, a function of mechanically creating a digest version from the original program. In this case, it is feasible to designate a length of time (5 min, 10 min, an arbitrary period of time, etc) of the digest program from which to reproduce the highlight scene.

On the other hand, the stretch reproduction function is a function enabling a magnification of speed when reproduced to be designated such as x1.0→x1.2→x1.5→x2.0= . . . . A reproducing device adjusts a period of viewable time at the designated magnification. If the magnification falls within a predetermined limit, voices can be also reproduced.
[Patent document 1] Japanese Laid-Open Patent Publication No. 2008-004170
[Patent document 2] Japanese Laid-Open Patent Publication No. 2006-180305
[Patent document 3] Japanese Laid-Open Patent Publication No. 2007-028368
[Patent document 4] Japanese Laid-Open Patent Publication No. 2005-223451

The conventional technologies, though capable of completing the viewing till the desired time, cause such an inconvenience that there is a discrepancy between the scene selected for the highlight reproduction and a really-want-to-see scene of the user, with the result that the user “misses seeing” the want-to-see scene due to a case of not being extracted. Further, in the stretch reproduction, the reproduction is finished till the target time, and hence such a case arises that the reproduction is performed at a reproduction speed as high as disabling the user from sufficiently understanding a recorded content. In any case, the conventional viewing technologies are not friendly to the users. Note that the similar problem might arise in only-voice-based programs with no picture.

It is an aspect of the technology of the disclosure to provide a technology capable of adjusting the reproduction time of program data stored on a storage medium and enhancing a possibility that a part of the program assumed to be desired by the user can be provided at a reasonable reproduction speed.

### Means for Solving the Problems

### SUMMARY

According to an aspect of the embodiment, a program data processing device includes a reading unit, a feature extracting unit, a weight acquiring unit and a weighting unit. The reading unit reads a data part contained in program data from a file stored with program data. The feature extracting unit extracts feature information for distinguishing between reproduction information to be reproduced from the data part and reproduction information to be reproduced from another data part. The weight acquiring unit acquires a weight set on the extracted feature information from a weight table storage unit in which to set the weight per feature information contained in the program data. The weighting unit allocates the acquired weight to the data part from which the feature portion is extracted.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a diagram illustrating an example of a program segmented into scenes.

FIG. 2 is a diagram of an example of hardware and functions of an audiovisual device.

FIG. 3 is a diagram illustrating an example of a weight table.

FIG. 4 is a diagram illustrating the example of the weight table.

FIG. 5 is a diagram of an example of a scene feature table.

FIG. 6 is a flowchart illustrating a processing flow of a viewing process.

FIG. 7 is a flowchart illustrating details of a weighting process.

FIG. 8 is a flowchart illustrating details of a reproducing process.

FIG. 9 is a flowchart illustrating a processing flow of a weight table generating process.

FIG. 10 is a diagram illustrating a weight setting operation on a chapter screen.

FIG. 11 is a diagram illustrating a structure of a chapter image management table.

FIG. 12 is a flowchart illustrating a processing example of a chapter image selecting process.

FIG. 13 is a diagram illustrating a processing example of detecting a variation on the screen.

FIG. 14 is a flowchart illustrating a processing example of a screen change detecting process.

FIG. 15 is a diagram illustrating an example of a scene feature table.

### DESCRIPTION OF EMBODIMENT

An audiovisual device according to an embodiment will hereinafter be described with reference to the drawings. A configuration in the following embodiment is an exemplification, and the present technology is not limited to the configuration in the embodiment.

<Outline of Processing>

The audiovisual device segments video data of a video file into plural frames (video frames) of scene data (corresponding to a data part), and puts a weight on each scene. Herein, the “scene” is defined as a concept for delimiting reproduction information of a video picture, sound, voice, a story, etc which are reproduced (played back) from the video file. The scene data is defined as data for reproducing a scene delimited from other scenes on the basis of features of the reproduction information of the video picture, the sound, the voice, the story, etc. The scenes can be, though delimited based on differences in audiovisual effect between the video picture, the sound, the voice, the story, etc, also simply delimited on a time-designation basis. For example, delimiters are the time-designations of a scene 1 ranging from a start to N1 and a scene 2 ranging from N1 to N2. Further, the scenes can be also delimited in a manner that designates the frames as a concept equivalent to the time-designation. For instance, the scene 1 is delimited in a way that ranges from the frame 0 to the frame N1, and the scene 2 is delimited ranging from the frame N1 to the frame N2. Moreover, the scenes can be also delimited based on composition information which composes a program. The composition information of the program, e.g., a certain variety show program is organized by a guest feature (up to 15 min since the start), a commercial 1 (ranging from 15 min up to 16 min), a gourmet feature (from 16 min up to 30 min), a commercial 2 (from 30 min up to 31 min), a gift feature (from 31 min up to 40 min), etc. The composition information such as this can be obtained from, e.g., an EPG (Electronic Program Guide).

Then, a reproduction speed is changed on a per-scene basis according to the weight thereof. Namely, the scene presumed to be suitable for a user's preference or taste is reproduced at a normal speed, while the scene presumed to be unsuitable for the user's preference or taste is reproduced at a higher speed than the normal speed. This type of adjustment enables such a possibility to be enhanced that the user can surely view the video file in a predetermined period of reproduction time (within, e.g., the time designated by the user) and can view the scene which the user has an interest in.

Herein, the video file is created by, e.g., recording a televised program. The video file is not, however, limited to the recorded file and may involve using the data available by a variety of methods, e.g., the video file provided in the way of being stored on a storage medium. Further, the weight is set from a history of operations with respect to the programs that were viewed by the user in the past. For instance, the program viewed in the past is segmented into the plurality of scenes, features of the respective scenes are extracted, and the history of the operations conducted by the user when reproducing these scenes is collected. Then, when the operation history indicates fast-forwarding, the audiovisual device determines that the user does not show any interest in the scene or alternatively the scene is not matched with the user's preference or taste. As a result, the audiovisual device decreases the weight on the feature of this scene. By contrast, when the user returns the reproduction speed to the normal reproduction speed from the fast-forwarding status, the audiovisual device determines that the scene at that time is matched with the user's preference or taste. Then, the audiovisual device puts a heavy weight on the feature of this scene. Herein, the “normal reproduction speed” in terminology connotes a 1× speed at which to reproduce the data without the so-called fast-forwarding.

The feature of the scene is determined in a manner that extracts items of information related to the program given in the EPG, such as a sound volume level at each scene, a change in sound level, characters displayed on a screen at each scene, a change or no-change in character, words contained in an uttered voice at each scene, words given to the setting to which each scene belongs in the program, a degree of change of the screen and the information related to the program shown in the EPG.

Herein, the “characters displayed on the screen” are exemplified by a subtitle, a score in a sports program, etc. The “change or no-change in character” implies a case in which the score in the sports program changes, and so on. Moreover, the “information related to the program shown in the EPG” implies, for example, a title, performers, a rough plot, etc which are given to each section in such a case that the variety show program includes a combination of a plurality of sections of the guest feature, the gourmet feature and the gift feature. The sections organizing the program such as that and the broadcasting time of the section can be obtained from the EPG data. Further, the EPG can be acquired from a Web site on the Internet. The audiovisual device stores a relation between the features of the scenes and the weights in a storage means such as a memory or a hard disc in a weight table format.

Then, the audiovisual device segments the video file stored on the medium such as the hard disc into the plurality of scenes and reads the weight by searching through the weight table on the basis of the feature of each of the scenes. Subsequently, the readout weight is set to each scene.

A reproducing device undergoes a designation of reproduction time given from the user. Then, if the designated reproduction time is shorter than the original reproduction time of the video file, the reproducing device adjusts the reproduction time of each scene, thus controlling the reproduction time of the whole video file to converge on the reproduction time designated by the user.

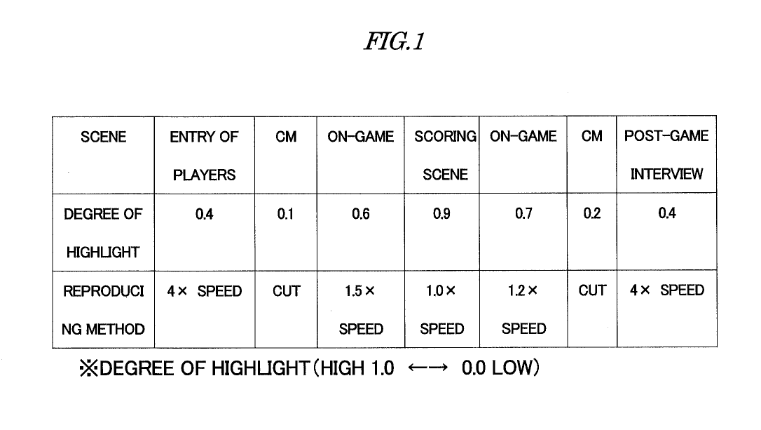

FIG. 1 illustrates an example of the program segmented into the scenes. An assumption in FIG. 1 is to broadcast a sports game. In FIG. 1, the program is segmented into, e.g., entry of players, commercials, an on-playing game, a scoring scene, the on-playing game, a post-game interview, etc.

When the words such as [entry of players], [start of game], [kickoff], [play ball], [end of game], [game and set] and [hero interview (flash interview)] are detected from the words of the uttered voices that are broadcasted, the starts of the respective scenes may be presumed. Further, when a numeral in the subtitle indicating the score is changed, this scene may be presumed to be the scoring scene. Still further, when detecting words such as [goal], [safe at home plate], [home-run] from within the uttered voices, the scenes before and after detecting these words may be presumed to be the scoring scenes.

Then, the weight as small as 0.1 or 0.2 is set to the “commercial”, while the weight as large as 0.9 is set to the “scoring scene”. Further, 0.6 or 0.7 is weighted on the “on-playing game” (excluding the “scoring scene”), and the numerical values smaller than the value of the “on-playing game” are weighted on the “entry of players” and the “post-game interview”.

Then, the scenes weighted by 0.2 or smaller are cut so as not to be reproduced. Moreover, in the case of the weight of 0.9 or more, the scene is reproduced at the 1× speed, i.e., at the normal reproduction speed. Further, the 0.4-weighted scene is reproduced at a 4× speed. Still further, in the case of the weight ranging from 0.6 to 0.7, each scene is played back at an intermediate speed, e.g., 1.2× or 1.5× speed between 1× speed and 4× speed.

### FIRST WORKING EXAMPLE

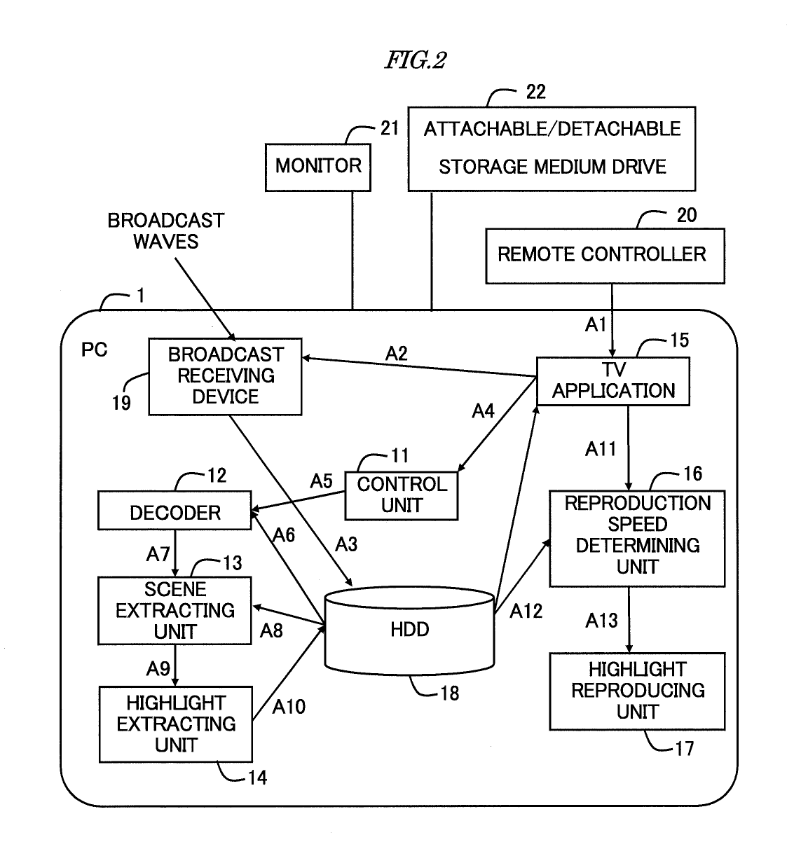

An audiovisual device 1 according to a first working example will hereinafter be described with reference to FIGS. 2 through 6. FIG. 2 is a block diagram depicting an example of hardware and functions of the audiovisual device 1. As in FIG. 2, the audiovisual device 1 includes: a broadcast receiving device 19 which receives a television program via broadcast waves; a hard disc drive 18 stored with the received TV program in a video file format; a decoder 12 which decodes the data of the video file on the hard disc drive 18; a scene extracting unit 13 which segments the decoded program into a plurality of scenes; a highlight extracting unit 14 which extracts especially a want-to-see highlight scene of the user from the plurality of segmented scenes; a highlight reproducing unit 17 which highlight-reproduces the data of the video file on the hard disc drive 18; a reproduction speed determining unit 16; a TV application program 15 (that will hereinafter be simply termed the application 15) which controls the broadcast receiving device 19, the hard disc drive 18, the highlight reproducing unit 17, etc; and a control unit 11 which executes the application 15 and realizes the functions of the audiovisual device 1. Further, the audiovisual device 1 is operated by a remote controller (which will hereinafter be abbreviated to the RC 20). Note that the audiovisual device 1 includes, other than the RC 20, unillustrated input devices (e.g., a pointing device such as a mouse, and a keyboard). The audiovisual device 1 can be exemplified by a personal computer (PC), a TV receiver incorporating an information processing function, a personal digital assistant (PDA), a hard disc recorder, a set-top box for TV broadcast, etc.

Then, a video picture reproduced by the audiovisual device 1 is displayed on a monitor 21. The monitor is exemplified such as a liquid crystal display, an electroluminescence panel, a plasma display, a CRT (Cathode Ray Tube).

Moreover, an attachable/detachable storage medium drive 22 is externally connected to the audiovisual device 1 or alternatively can be built in a housing of the audiovisual device 1. An attachable/detachable storage medium is, e.g., a CD (Compact Disc), a DVD (Digital Versatile Disk), a Blu-ray disc, a flash memory, etc. The attachable/detachable storage medium drive 22 reads the video data from the medium stored with the video file. Further, the attachable/detachable storage medium drive 22, when installing the application 15 etc, reads the program from the medium and downloads the program into the hard disk.

The control unit 11 includes a CPU (Central Processing Unit) and a memory, in which the CPU executes a computer program deployed on the memory in an executable-by-CPU format. One of the computer programs such as this is the application 15. Note that the application 15 is, before being deployed on the memory, stored on the hard disc drive 18 or an unillustrated ROM (Read Only Memory). The control unit 11 accepts a user's operation via, e.g., the RC 20 and controls a recording reservation process, a receiving process based on the recording reservation, and the recording process.

Moreover, the control unit 11 accepts the user's operation via the RC 20, and executes the reproduction of the recorded TV program. On the occasion of the reproduction, the control unit 11 accepts a designation of the reproduction time or reproduction ending time from the user. Subsequently, if the reproduction time or a period of time ranging from the present time to the reproduction ending time is shorter than the recording time of the recorded program, the control unit 11 executes the highlight reproduction according to the embodiment.

The broadcast receiving device 19 demodulates the broadcast waves received by an antenna, and thus acquires signals of the TV programs. The broadcast receiving device 19 is exemplified by a TV tuner receiving an analog broadcast, a HDTV (High Definition Television) tuner receiving a digital broadcast, or a tuner for a 1seg (one segment) broadcast which uses one segment in HDTV-based channels. As for both of the analog broadcast and the digital broadcast, a configuration of the broadcast receiving device 19 is broadly known, and hence an in-depth description thereof will be omitted.

The acquired signals of the TV program are temporarily stored on the hard disc drive 18. The decoder 12 decodes the signals of the TV program stored on the hard disc drive 18, thus generating the video data. The video data is segmented by the scene extracting unit 13 into the scenes each consisting of the plurality of frames (video frames). A scene feature is extracted from each scene. The scene feature is stored together with information for specifying each scene in the form of a scene feature table in the memory of the control unit 11.

Furthermore, the highlight extracting unit 14 searches through, based on the scene features, the weight table and allocates the weights to the respective scenes. The weights are stored in the scene feature table. The scene extracting unit 13 and the highlight extracting unit 14 are realized in the form of the computer program executed by the control unit 11.

The video data generated by the decoder 12 and the scene feature table are stored on the hard disc drive 18. Note that if the video data demodulated by the broadcast receiving device 19 is not yet encrypted, the decoding process of the decoder 12 is omitted. Further, the processing target video data described above may be either the analog data or the digital data. Moreover, the broadcast receiving device 19 may capture the analog signals or the digital data of the TV program from a cable network instead of receiving the broadcast waves from the antenna.

A reproduction speed determining unit 16 is defined as one of the computer programs executed by the control unit 11. The reproduction speed determining unit 16 determines, when reproducing the video data in the hard disc, a reproduction speed on the basis of the scene feature table generated based on the video data. The highlight reproducing unit 17 reproduces each scene in accordance with the reproduction speed designated by the reproduction speed determining unit 16. The highlight reproducing unit 17 may be configured as the computer program executed by the CPU of the control unit 11 and may also be configured as a hardware circuit. In any case, the highlight reproducing unit 17 determines the scene to which the respective frames belong according to a frame count from a start position of the TV program, and adjusts the output frame count per unit time of the scene concerned.

An operational example of the audiovisual device 1 will hereinafter be discussed. To start with, the user makes a recording reservation of, e.g., a program of a soccer game by use of the RC 20 (arrows A1-A3). After completing the recording based on the recording reservation, the scene extracting unit 13 and the highlight extracting unit 14 are started up under the control of the control unit 11, thereby executing the extraction of the highlight scene and a computation of the weight on the scene (arrows A4-A10). For example, sound volumes of the respective scenes are compared, and an assumption is [Scene with Loud Sounds=Exciting], which is extracted as the scene feature. The audiovisual device 1, however, determines, based on an operation history of how the user behaved in the past when reproducing the scene containing such a feature without depending simply on the scene feature, whether a heavy weight is put on the scene or not.

For viewing the recorded scene, the user starts up the application 15 by using the RC 20 (arrow A1). Here at, the control unit 11 executing the application 15 displays a recording program list on a monitor screen. The user selects the recording program of the soccer game broadcasted by relay, and further specifies the time when the user wants to complete the reproduction. The application 15 accepts these operations and executes the process of reproducing the recording program. At this time, the control unit 11 executes the reproduction speed determining unit 16 (A11) and computes the reproduction speed based on the weight so as to converge within the specified period of time. Furthermore, the control unit 11 executes the highlight reproducing unit 17, thereby performing the highlight reproduction according to the reproduction speed (arrows A11-A13).

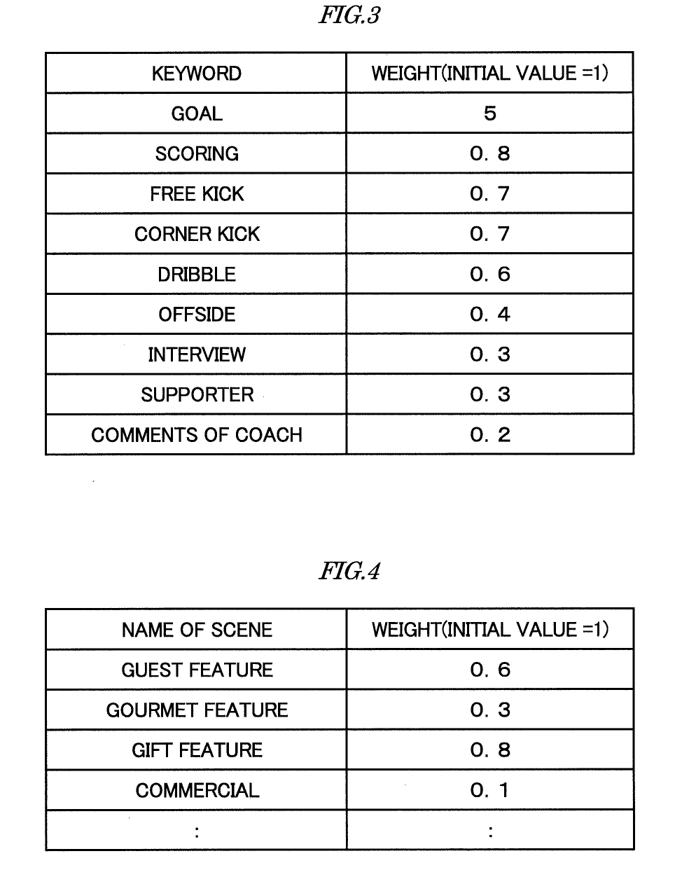

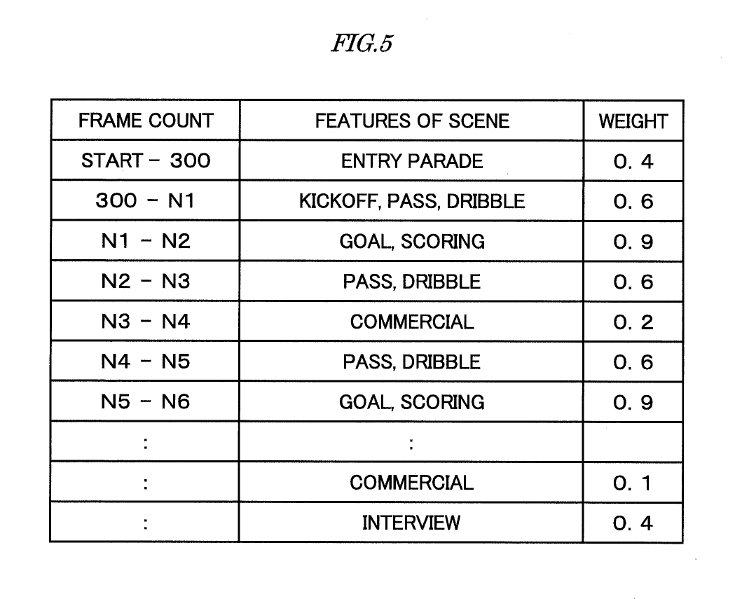

FIGS. 3 and 4 illustrate examples of the weight tables. The memory of the control unit 11, which is stored with the weight table, corresponds to a weight table storage unit. The weight table in FIG. 3 gives an example of how the weights are allocated to keywords extracted from the uttered voices at the respective scenes of the soccer game. The audiovisual device 1 segments the video file containing the record of the soccer game into the scenes including one or plural video frames. Then, the audiovisual device 1 detects the history of the user's operation with respect to the keyword extracted from each scene. Subsequently, the weight is determined based on the operation history when the user views the scene containing this keyword.

For instance, if the user prefers the scoring scene, i.e., a goal scene, the user views the scene containing the uttered word [Goal !] at the 1× speed in many cases, and it follows that the history of this operation is recorded often. Further, if the user is not interested in post-game comments of a coach, the video is fast forwarded at a 4× speed in the majority of cases, and the history of such an operation is frequently recorded.

Accordingly, it may be sufficient that the keywords characterizing the respective scenes are weighted in the way of being associated with the detected user's operations (or the reproduction speed when viewing, etc). For instance, after setting an initial value “1” to each keyword, in the case of viewing at an Nx speed (N-fold speed), the present weight is set to 1/N-fold, and so forth. Thereupon, with respect to the initial value “1”, as a fast-forwarding speed is accelerated and a fast-forwarding count is incremented, the weight becomes smaller. It is therefore feasible to distinguish between the scene in which the user is interested and the scene in which the user is not interested on a per-user basis according to the viewing history and to set a proper weight on each scene.

Moreover, an available scheme is that an additional point to be added is prescribed corresponding to the user's operation (or the reproduction speed when viewing, etc) (a point “0” is set to 2× speed or faster, a point “1” is set to 1×-2× speed, and a point “3” is set to 1× speed), and the additional point is added each time the individual operation is detected, thus totalizing the points for the respective keywords. Then, the points may also be normalized so that the weights of the individual keywords are distributed in a range of 0-1.

The weights as in FIG. 3 maybe, without being limited to the soccer game, collected in common to all categories of TV programs. If a sample count is small, the common weight table may be utilized without depending on the categories of the TV programs. Further, a multiplicity of user's operation histories is accumulated, and, if a tremendous number of relations between the keywords and the users (or the reproduction speeds when viewing) can be collected, the weight tables as in FIG. 3 may be generated corresponding to the categories of the programs. This is because the extractable keywords differ corresponding to the categories of the TV programs, and hence it can be presumed that the weight accuracy rises by providing the weight table on a category-by-category basis. For example, the terminology of the soccer is different from the terminology of the baseball, and therefore, in the case of the soccer game, the more elaborate setting of the weights can be done by setting the weights in a manner that puts a focus on the terminology used in common to the soccer terminology and the TV program terminology.

FIG. 4 illustrates an example of categorizing the scenes based on the composition information of the programs extracted from the EPG and allocating the weights to the scenes. A subtitle (which will hereinafter be referred to as a scene title) of the scene partly composing each program is contained in the data included in the EPG. For instance, in the case of the variety show program, the subtitles are the “guest feature”, the “gourmet feature”, the “gift feature”, the “commercial”, etc. Such being the case, the audiovisual device 1 segments the program into the scenes on the basis of the pre-acquired EPG, and may give the scene titles to the respective scenes. Each scene can be identified from the elapse time since the start of the program or from the frame count. Then, the weights are set to the respective scenes on the basis of the user's operations (or the reproduction speed when viewing) at these individual scenes. The weight setting procedure is the same as in the case of FIG. 3. For example, when viewing the “guest feature” at the 1× speed, the present weight is doubled (2-fold). Further, when viewing the “gourmet feature” at the 3× speed, the present weight is set to 1/3-fold. Another available method is to totalize the points in a way that prescribes the additional points to be given corresponding to the respective user's operations (or the reproduction speeds when viewing).

FIG. 5 illustrates an example of the scene feature table of the scene features given to the recorded video data of the soccer game on the basis of the weight table of FIG. 3. The memory of the control unit 11, which is stored with the scene feature table, corresponds to a reproduction data weight storage unit. Namely, the user makes the recording reservation, the recording is carried out, and the video file is created, at which time the scene feature table as in FIG. 5 is generated for each video file. The scene feature table contains a “frame count” field, a “scene feature” field (keyword) and a “weight” field.

In the scene feature table, each scene is identified by the frame count. For example, the scenes are segmented in a way that ranges from the start to the 300th frame, from the 301st frame to N1-frame (N is an integer equal to or larger than 301), and so on. The example in FIG. 5 is that the keyword characterizing the scene is recorded on the per-scene basis. It does not, however, imply that the scene feature is limited to the feature specified by the keyword.

The audiovisual device 1 searches through the weight table in FIG. 3 on the basis of the keyword representing each scene feature and puts the weight thereon. When the scene feature table in FIG. 5 is generated, the audiovisual device 1, if the reproduction time (or the reproduction ending time) designated by the user is shorter than the recording time of the recorded program, adjusts the reproduction speed corresponding to the weight, and reproduces the heavy-weight scene at the normal reproduction speed to the greatest possible degree but fast-forwards the light-weight scene at a highly-multiplied double-speed. Under the control such as this, the reproduction of the recorded program is controlled to be ended at the reproduction time (reproduction ending time) designated by the user, and the user avoids missing the program in which the user is interested to the greatest possible degree.

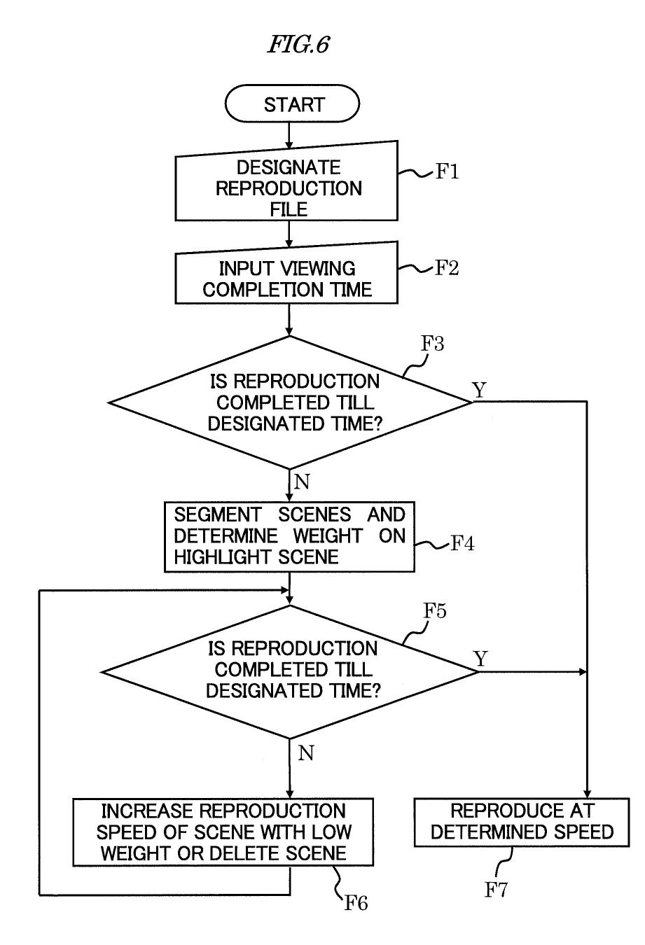

FIG. 6 illustrates a processing flow of the viewing process of the audiovisual device 1. This viewing process is realized in such a way that the CPU of the control unit 11 executes the application 15. To begin with, the user designates a reproduction target video file (which will hereinafter be simply termed a reproduction file) and want-to-complete-viewing time from on a user interface (UI) of the audiovisual device 1 (F1, F2). The user interface is realized by displaying the monitor screen of the audiovisual device 1 and by the RC 20 operation corresponding to the display.

Upon receiving the user's designation, the audiovisual device 1 determines whether or not the reproduction is completed within the designated time (F3). The reproduction time required for reproducing the file can be determined from the frame count described in the reproduction file, the reproduction time described on the medium or the recording elapse time recorded in the reproduction file.

If the reproduction is not finished within the desired time (N at F3), the scenes of the reproduction file are segmented, and the weights are set on the per-scene basis (F4). The reproduction time of each scene is set so as to fall within the time by changing the reproducing method (e.g., the reproduction speed) based on the per-scene weighting technique (F5-F6). The setting is that the scene exhibiting, for instance, the high degree of highlight, i.e., the heavy-weight scene is reproduced at the normal reproduction speed. Another setting is that the scene exhibiting the intermediate degree of highlight is reproduced by fast-forwarding, i.e., at the 2× speed. On the other hand, the scene exhibiting the small degree of highlight as in the case of the commercial is cut (the scene is eliminated). Then, the audiovisual device 1 reproduces the reproduction file at the set-up reproduction speed (F7).

Thus, the reproduction time gets variable depending on the degree of highlight, i.e., depending on the weight. Note that the user may perform the setting enabled to transition to the next scene any time by pressing a [skip] button on the RC 20 etc. Similarly, during the double-speed reproduction, the setting may be such that the mode can transition to the normal reproduction any time by pressing a [reproduction] button on the RC 20 etc. Moreover, these operations on the RC 20 are stored beforehand and may also accumulated as reference information on the occasion of determining the degree of highlight.

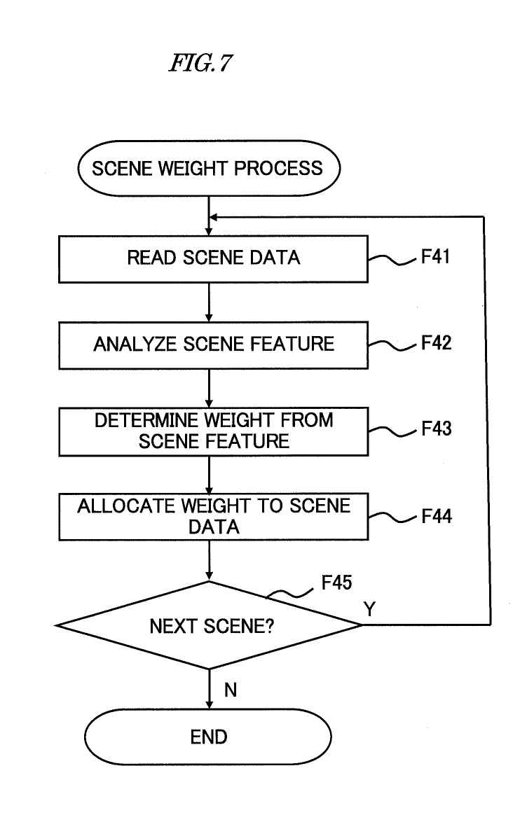

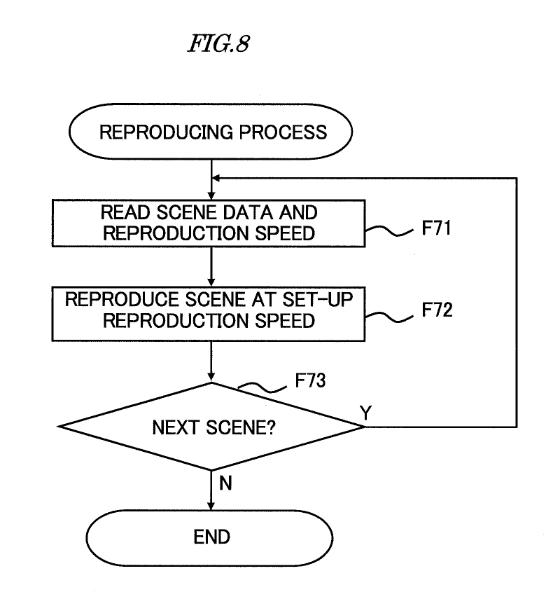

FIG. 7 illustrates details of the weighting process (F4 in FIG. 6). In this process, the audiovisual device 1 reads the scene data from the video file (F41). The CPU of the control unit 11, which executes this process, corresponds to a reading unit.

Then, the audiovisual device 1 extracts the scene feature by analyzing the scene data (F42). For example, the scene feature is determined from the uttered word (as the keyword) detected in the voice data. To be specific, the audiovisual device 1 vocally recognizes the voice data and thus extracts the keyword. The voice recognition involves collating combinations of consonants and vowels of the voice data with a predetermined set of dictionary data. A specific process of the voice recognition has already been known, and therefore the detailed explanation thereof is omitted. If the category of the TV program is known, however, any inconvenience may not be caused by changing the voice recognition dictionary on a category-by-category basis. This is because, for instance, the in-voice words uttered in the soccer game are limited in number to some extent. The extracted scene feature, i.e., the keyword is stored in the format of FIG. 5 in the scene feature table. Accordingly, a scene segmenting procedure is that one single scene may be configured by, when detecting the keyword, the frame containing this detected keyword and a predetermined number of frames anterior and posterior to the keyword-contained frame in the way of being associated with the keyword. The CPU of the control unit 11, which executes this process, corresponds to a feature extracting unit.

Next, the audiovisual device 1 determines, based on the extracted keyword, the weight with reference to the weight table (F43). The CPU of the control unit 11, which executes this process, corresponds to a weight acquiring unit. Then, the weight is allocated to the scene (F44). The CPU of the control unit 11, which executes this process, corresponds to a weight allocating unit. Subsequently, the audiovisual device 1 determines whether the next scene data (i.e., the next frame) exists or not (F45). If the next scene data exists, the audiovisual device 1 advances the control to F41. Whereas if the processing for all of the scenes is terminated, the audiovisual device 1 finishes the scene weighting process.

Note that a scheme of the present working example is to execute the scene weighting process during the reproducing process illustrated in FIG. 6, however, after completing the recording or after inserting the medium into the attachable/detachable storage medium drive 22, the processes in FIG. 7 may be executed previously before the user views the video file.

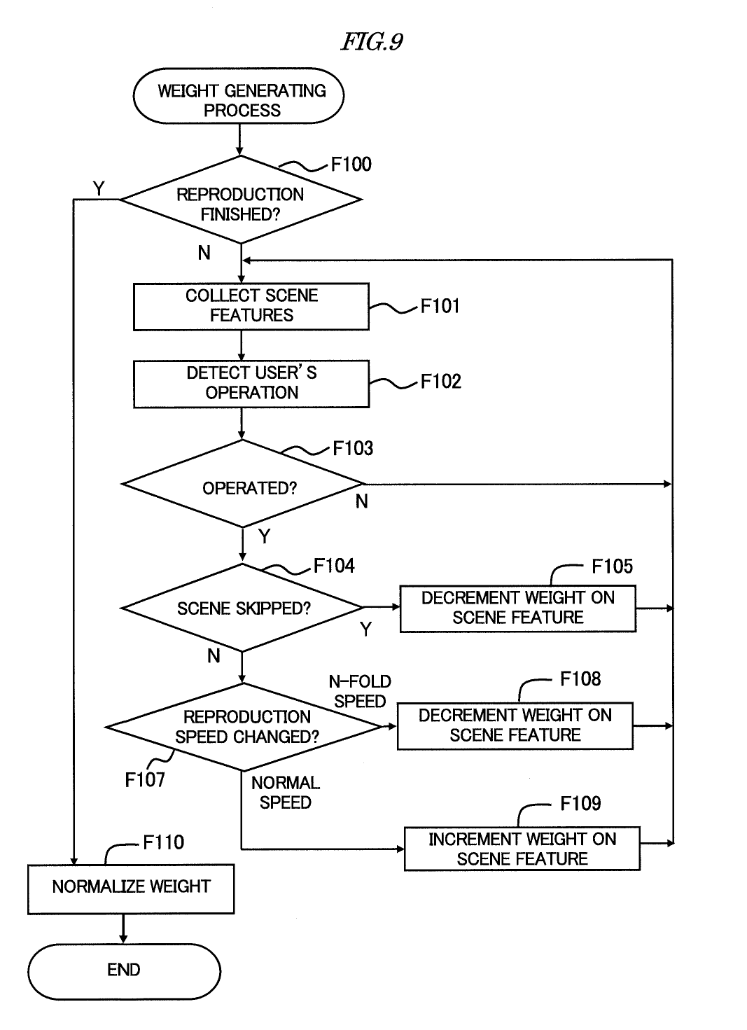

FIG. 8 illustrates details of the reproducing process (F7 in FIG. 6). The CPU of the control unit 11, which executes this process, corresponds to a reproducing unit. In this process, the audiovisual device 1 reads the reproduction speed set for this scene in F6 of FIG. 6 (F71). Then, the audiovisual device 1 reproduces the scene at the set-up reproduction speed (F72). Note that if the scene weight is equal to or smaller than a predetermined value, the scene data itself may be cut without reproducing this scene.

As discussed above, the audiovisual device 1 according to the present working example enables the user to view the video within the time in a manner that comprehends the content of the video such as enabling the important scene to be viewed at the normal reproduction speed while cutting the unnecessary scene. In this case, the determination as to which scene is cut, which scene is fast forwarded and which scene is reproduced at the normal reproduction speed, is made based on the weight allocated to the scene feature. Further, even the non-cut scene, if not matched with the user's preference or taste, can be fast forwarded. Owing to the combinations of the reproduction speeds, it is feasible to finish the reproduction till the time desired by the user and to reduce the possibility that the user might miss a part (scene) in which the user is interested.

Note that if a have-an-interest-in player appears for the post-game interview, the setting is that the normal reproduction can be done by pressing the [reproduction] button on the RC 20. Further, the setting in the case of pressing a [skip] button on the RC 20 may be such that the operation transitions to the next scene. Moreover, the reproducing method during the playback may invariably be displayed in order for the user not to get confused. A display is, e.g., [On-Highlight-Reproduction] etc.

### SECOND WORKING EXAMPLE

The audiovisual device 1 according to a second working example will hereinafter be described with reference to FIG. 9. The second working example will discuss a process in which the audiovisual device 1 is stored with the on-playback operation history and generates the weight table. The weight table is utilized to put the weight on the scene for the reproduction of the next time.

FIG. 9 illustrates a processing flow of a weight table generating process executed by the audiovisual device 1. The CPU of the control unit 11, which executes this process, corresponds to a weight generating unit. In this process, the audiovisual device 1 determines whether the reproduction is finished or not (F100). If the reproduction is not yet finished, the audiovisual device 1 collects the scene feature from the data of the on-playback scene at the present time (F101). The scene feature is, e.g., the uttered word, i.e., the keyword in the voice data. The scene feature can, however, involve using, other than the voice data, various types of data such as a sound level, a change in sound level, character information displayed on the screen, a change in character information, words of the program in the EPG and a level of change of the scene on the screen. The collected scene feature is stored in the scene feature table. The scene feature table takes, e.g., the format in FIG. 3. At this time, an initial value (e.g., the weight “1”) is set as the scene weight.

Together with collecting the scene feature, the audiovisual device 1 detects the user's operation from on, e.g., the RC 20 (F102, F103) (the RC 20 or an unillustrated input device corresponds to an operation detecting unit). Then, when detecting the operation, the audiovisual device 1 determines whether the detected operation indicates a skip of the scene or not (F104). If the detected operation indicates the skip, the weight on the scene feature is reduced (F105). For example, the weight is reduced by one count (or alternatively, the weight is multiplied by 1/(2M), where M is a magnification of the fastest-forwarding with respect to the normal reproduction speed). Then, the audiovisual device 1 loops the control back to F101.

If the operation does not indicate the skip of the scene, the reproducing device 1 determines whether the operation indicates a change in reproduction speed or not (F107). If the detected operation indicates an increase up to N-fold speed, the weight on the scene feature is decremented (F108). For example, the weight is decremented by 0.5 count (or alternatively the weight is multiplied by 1/N). Then, the audiovisual device 1 loops the control back to F101. Further, the audiovisual device 1 increments the weight on the feature of the scene about which the detected operation indicates the change in normal reproduction speed (F109). For instance, the weight is incremented by 1 count (or alternatively the weight is doubled). Subsequently, the audiovisual device 1 loops the control back to F101.

Moreover, upon finishing the reproduction (N in F100), the reproducing device 1 normalizes the weights of the scene feature table to the range of 0-1 (F110). To be specific, the weight values are converted based on the weight set in the processes of F101-F109 in the range of the minimum value “0” through the maximum value “1”. As for the conversion, the numerical value may be converted based on the computed weight by use of a linear function. Further, the weight characteristic is changed together with the conversion, and hence the value may also be converted by use of a curvilinear function.

The weight can be set on the scene feature on the per-scene basis according to the history of the user's operations in the processes described above. Note that the process of reproducing the video file on the basis of the set-up weight is the same as in the first working example.

### MODIFIED EXAMPLE

In the first working example, the scene feature is extracted based on the information acquired by processing the video data such as the keywords etc contained in the voice data. As a substitute for this process, as illustrated in FIG. 4, the scenes may be segmented based on the scene composition in the program that can be obtained from the EPG. Then, the user's operation is detected on the per-scene basis, and the scene weight may be set in the same procedure as in FIG. 9. The set-up weight maybe stored in the table containing the entry per scene.

Subsequently, the weights may be allocated to the respective scenes with reference to the set-up weights according to the history acquired in the past when reproducing the program having the similar program composition. This technique enables the scenes to be segmented based on the EPG.

### THIRD WORKING EXAMPLE

A processing example of the audiovisual device 1 according to a third working example will hereinafter be discussed. In the third working example, the audiovisual device 1 displays a reduced image (which will hereinafter be termed a chapter image) of the frame partly composing the video picture on the monitor screen. In the third working example, the chapter image represents a head frame (or representative frame) of each scene. A plurality of chapter images may also be displayed on the per-scene basis. In this case, the audiovisual device 1 may select the chapter image in accordance with a predetermined standard per scene such as the degree of change in screen, the degree of change in sound and a change in character and may display the selected chapter image.

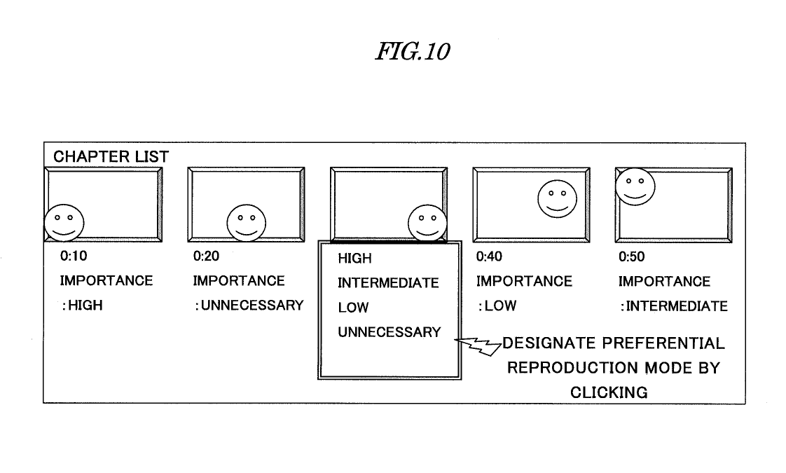

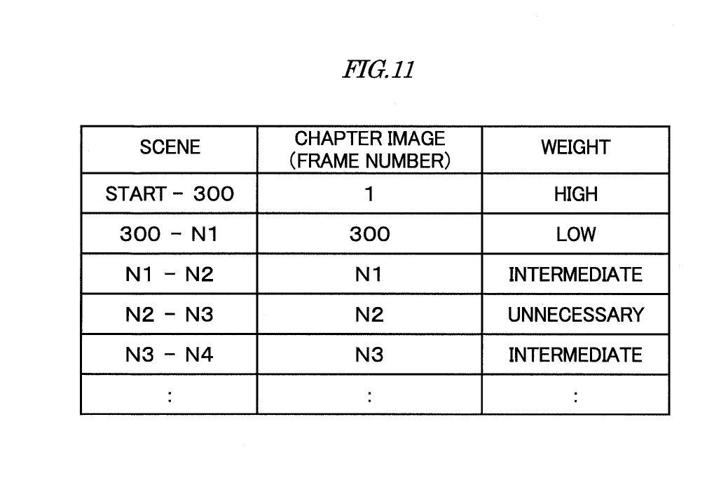

Then, the audiovisual device 1 accepts the user's operation about the chapter image. The audiovisual device 1 sets the weight on each chapter image, i.e., each scene according to the user's operation. FIG. 10 is a diagram depicting the weight setting operation on a chapter screen.

The following is a working example in a case where the user sets the weight on the scene.
1. To make the record reservation of the soccer game.
2. To open the setting screen after completing the record reservation.
3. To display a chapter list of the soccer game (see FIG. 10). The monitor 21, which displays the chapter list in FIG. 10, corresponds to a static image display unit.
4. To change the weight on the scene by selecting the chapter. The scene weight is set on the scene to which each chapter image belongs. Then, each scene weight is stored together with each scene feature in the same table (which will hereinafter be referred to as a chapter image management table) as the scene feature table in FIG. 5.
5. To close the setting screen.

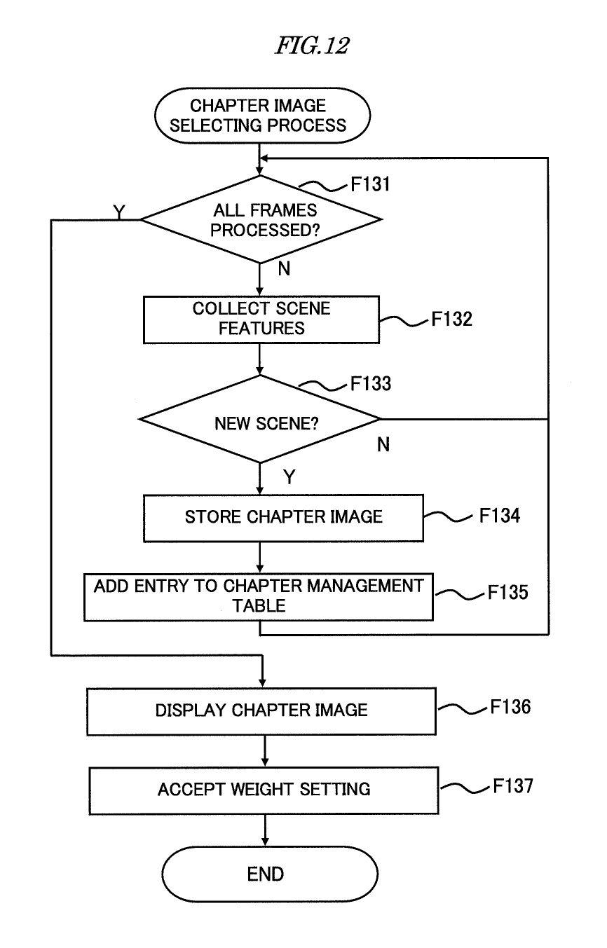

FIG. 11 illustrates a structure of the chapter image management table stored with a relation between the scene, the chapter image extracted from the scene and the weight set by the user. The chapter image management table contains a “scene” field, a “chapter image” field (“frame number” field) and a “weight” field. The scene is specified within the range of the frame number in the same way as in the scene feature table in FIG. 5. The chapter image is specified by the relevant frame number. An example of FIG. 11 is that the head frame of each scene corresponds to the chapter image. A plurality of chapter images may be selected from each scene. The weight is the weight set by the user.

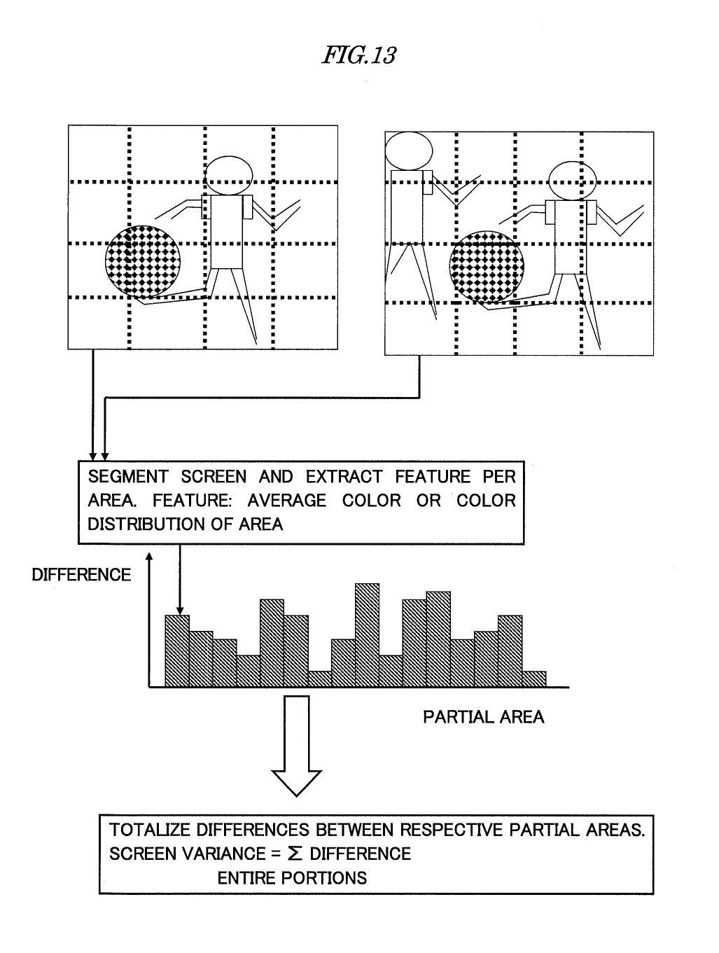

FIG. 12 illustrates a processing example of a chapter image selecting process executed by the audiovisual device 1. In this process, the audiovisual device 1 extracts the chapter image from the data of the video file recorded on the hard disc drive 18. In this process, the audiovisual device 1 determines whether all of the frames are processed or not (F131). If all of the frames are not processed, the audiovisual device 1 extracts the scene feature from the next frame group (S132). The frame count of the next frame group is set as a system parameter. For example, the scene features are extracted from ten frames.

The scene features are related to, e.g., whether the voice level is equal to or larger than a predetermined reference value, whether the voice level rises by the predetermined value or above, whether the numeral (which is a character portion indicating the score) changes on the screen, whether the image changes to a predetermined degree or greater, whether the voice belonging to the frame group contains the specified keyword (e.g., [goal], [scoring], etc), and so forth.

Then, the audiovisual device 1 determines whether a new scene should be defined from the collected scene features or not (F133). To be specific, the audiovisual device 1 determines that the new scene should be defined if applied to any one of the criteria as to whether the voice level is equal to or larger than the reference value, whether the voice level rises by the predetermined value or above, whether the numeral (which is the character portion indicating the score) changes on the screen, whether the image changes to the predetermined degree or greater, whether the voice belonging to the frame group contains the specified keyword, etc. Then, any one of the images (which is, e.g., the head image) in the frame group is stored as the chapter image on the hard disc drive 18 (F134). Further, the entry is added to the chapter image management table for managing the chapter images (F135). After the entry is added to the chapter image management table, the audiovisual device 1 advances the control to F131.

Further, when all of the frames are processed due to the determination in F131, the audiovisual device 1 displays the chapter image selected in the process described above (F136). Subsequently, the audiovisual device 1 accepts the weight setting according to the user's operation (F137).

Note that the video file reprocessing process based on the set-up weight is the same as in the first working example.

FIG. 13 illustrates a processing example of detecting a variation on the screen by way of one example of the scene feature extracting process. Demonstrated herein is an example of segmenting the frames into a plurality of areas and detecting the variation on the screen between the reference frame serving as a benchmark and a target image serving as a determination target as to whether to become the chapter image. For instance, a frame anterior by a predetermined frame count (e.g., 1 frame or 2 frames or 10 frames before) to the target image may be set as the reference image. Further, an average image of the frames contained in a predetermined section may also be set as the reference image.

In this process, the reference frame and the target frame are each segmented into partial areas. Then, a difference in feature quantity between the partial areas is computed. The feature quantity is defined as, e.g., an average color within the partial area (e.g., a color frequency value of each of RGB values, i.e., red, green and blue values). Moreover, the feature quantity is also defined as a color distribution, i.e., the RGB values of the respective pixels. Then, a total sum of the variations of the average R-value, G-value and B-value is set as the difference. Moreover, what a sum of the variations of the R-value, G-value and B-value on a per-pixel basis is integrated with respect to all of the pixels within the partial areas is set as the difference. Then, the variation on the screen is assumed to be a total value obtained by collecting the differences in the respective partial areas with respect to all of the partial areas.

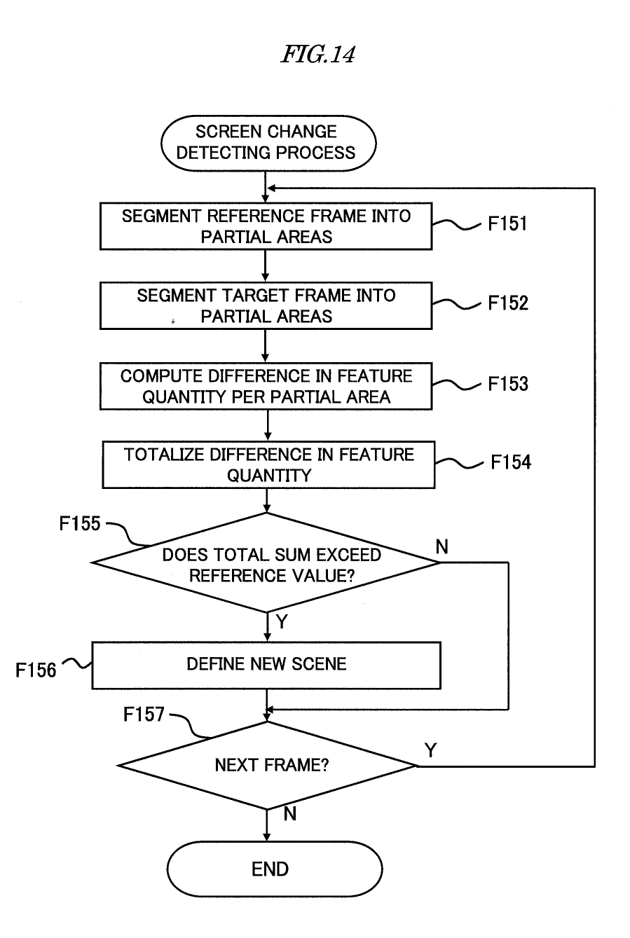

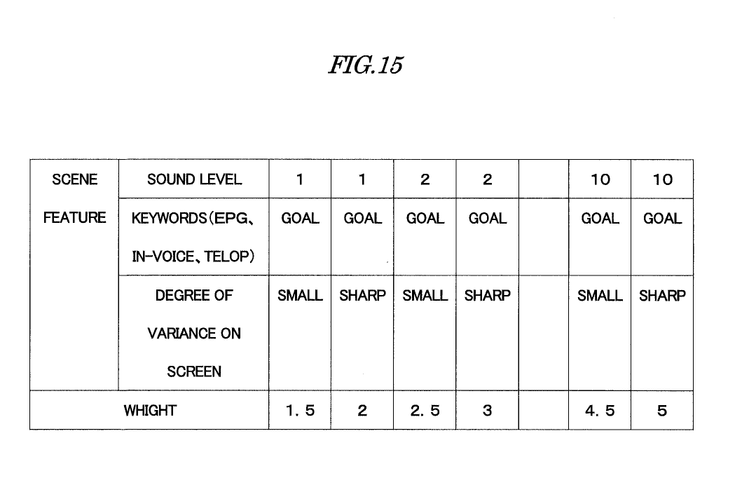

FIG. 14 illustrates a processing example of an on-screen variation detecting process. In this process, the audiovisual device 1 segments the pixels in the reference frames into the partial areas (F151). Next, the audiovisual device 1 segments the pixels in the target frame into the partial areas (F152). Then, the audiovisual device 1 computes the difference in feature quantity on a per partial area basis (F153). Subsequently, the audiovisual device 1 totalizer the differences in feature quantity on the per partial area basis with respect to all of the partial areas (F154).

Then, the audiovisual device 1 determines whether or not the total sum given in F154 exceeds a reference value (F155). The reference value is, e.g., an empirically accumulated value and can be set as a system parameter. Subsequently, if the total sum exceeds the reference value, a new scene is defined (F156). Specifically, a new entry is added to the chapter image management table depicted in FIG. 11, and the head frame is set. Moreover, the frame from which the screen variation is detected is registered as the chapter image. Set further is a tail frame (a frame one before the frame from which the screen variation is detected) of the scene generated one before the added entry.

Then, the audiovisual device 1 determines whether the next frame remains or not (F157). If the next frame remains, the audiovisual device 1 loops the control back to F151. While on the other hand, in the case of processing all of the frames, the processing comes to an end.

The chapter image can be extracted through the procedures described above. Note that the processing may be done in the same procedures in the case of extracting the chapter image on the basis of other features as to, i.e., whether the voice level is equal to or larger than the reference value, whether the voice level rises by the predetermined value or above, whether the numeral (which is the character portion indicating the score) changes on the screen and whether the voice belonging to the frame group contains the specified keyword (e.g., [goal], [scoring], etc).

Note that the numeral on the screen may be detected by pattern matching between the screen data and a numeral pattern. The keyword may also be detected by the pattern matching between the screen data and a character pattern. A character size of the subtitle, Telop (Television Opaque), the score of the sports game, etc may also be pattern-matched in a manner that narrows the character size down to a dimensional range acquired from the empirical value per program.

### FOURTH WORKING EXAMPLE

In the first working example, the scene feature is extracted based on, e.g., the keyword in the voice. This does not, however, mean that the scene feature is limited to the keyword in the voice. For example, the scenes can be categorized by use of the variety of scene features such as the sound level, the keyword associated with the program and the degree of the variation on the screen. The scene weight may also be put on each of the scenes categorized based on the variety of features through the user's operation when viewing the scene.

FIG. 15 illustrates an example of a scene feature table containing the extracted scene features on the basis of the sound level, the keyword and the degree of the variation on the screen. Herein, the sound level is a volume of the sound that is output from a loudspeaker in parallel with displaying the video picture on the monitor screen. Moreover, the keyword may be, without being limited to the word in the voice, a word acquired from the program contained in the EPG. The keyword may also be a word from the Telop on the screen. The degree of the variation on the screen can be obtained according to the processes in, e.g., FIGS. 12 and 13.

The weight may be set in the same way as by the processing in FIG. 9 through the operations performed by the user, such as the skip of the scene, the fast-forwarding and the playback in the normal status during the reproduction of the scene categorized based on these respective features.

Then, in the reproduction of the next similar program or the program of the similar category, the respective scenes are determined from the features described above, and the weights are set on the individual scenes. Subsequently, the weights may be stored in the scene feature table similar to the table in FIG. 5. Then, the reproduction speed is set according to the weight set in the scene feature table such as this, and the reproduction speed may be controlled so as to finish the reproduction of the program.

### OTHER PROCESSING EXAMPLES

Meta information of the program may be utilized for the weighting determination element. For instance, if a [news] program is recognized from the meta information of the program acquired from the EPG, an available scheme is not that the weighting is determined from loudness of the sound of the scene but that the weight is put on a portion of the news Telop.

Furthermore, the embodiment has exemplified the example of adjusting the reproduction speed when reproducing mainly the TV program. This process is not, however, restricted to the TV program and can be applied similarly to a radio program using only the sounds or the voices. Moreover, the program can be, without being confined simply to the broadcasting programs, similarly applied to programs stored in the data file acquired from the Internet, and movies, music, compositions, etc that are stored on the storage medium. Accordingly, when the present technology is applied, the terminology “program” includes the program of the TV broadcast, the program of the radio broadcast, the movie, the music, the composition, etc.

Further, in the embodiment, the weights are associated with the respective scenes in the scene feature table as illustrated in FIG. 5. In place of the scene feature table, however, the weights may also be set on the scene data, i.e., the portions (frames) corresponding to the individual scenes of each video file. Accordingly, the reproducing process may involve reading the weight together with the scene data and adjusting the reproduction speed according to the weight. This case does not require the scene feature table. Further, the scene weighting process in FIG. 7 and the reproducing process in FIG. 8 may be executed in parallel (or in real time). This case does not entail storing the scene weight and the scene in the way of being associated with each other.

<Readable-by-Computer Recording Medium>

A program for making a computer, other machines and devices (which will hereinafter be referred to as the computer etc) realize any one of the functions can be recorded on a recording medium readable by the computer etc. Then, the computer etc is made to read and execute the program on this recording medium, whereby the function thereof can be provided.

Herein, the recording medium readable by the computer etc connotes a recording medium capable of storing information such as data and programs electrically, magnetically, optically, mechanically or by chemical action, which can be read from the computer etc. Among these recording mediums, for example, a flexible disc, a magneto-optic disc, a CD-ROM, a CD-R/W, a DVD, a Blu-ray disc, a DATA (Digital Audio Tape), an 8 mm tape, a memory card, etc are given as those removable from the computer.

Further, a hard disc, a ROM (Read-Only Memory), etc are given as the recording mediums fixed within the computer etc.

What is claimed is:

1. A program data processing device comprising:
a reading unit to read a data part contained in program data from a file stored with program data;
a feature extracting unit to extract feature information for distinguishing between reproduction information to be reproduced from the data part and reproduction information to be reproduced from another data part;
a weight acquiring unit to acquire a weight set on the extracted feature information from a weight table storage unit in which to set the weight per feature information contained in the program data; and
a weighting unit to allocate the acquired weight to the data part from which the feature portion is extracted.

2. The program data processing device according to claim 1, further comprising a weighting reproduction unit to reproduce the program data by adjusting a reproduction speed according to the weight allocated per data part.

3. The program data processing device according to claim 1, further comprising a reproducing data weight storage unit stored with the weight in the way of being associated with the data part.

4. The program data processing device according to claim 1, wherein the data part is a data part segmented by delimitation based on a difference in viewing effect, delimitation based on a time designation, delimitation based on a frame designation or delimitation based on information specifying a program composition, and
the difference in viewing effect is detected from at least one of a change in picture, a change in sound, a sound level, existence or non-existence of character information and a change in character information.

5. The program data processing device according to claim 1, further comprising: an operation detecting unit to detect a user's operation when reproducing the data part, and
a weight generating unit to increment a weight on the feature information extracted from the data part when a user decreases the reproduction speed during the reproduction of the data part, decrement the weight on the feature information extracted from the data part when increasing the reproduction speed, and set the weight together with the feature information in the weight table storage unit.

6. The program data processing device according to claim 5, wherein the weight generating unit, when the reproduction of at least a portion of the data part is omitted, decrements the weight on the feature information extracted from the data part.

7. The program data processing device according to claim 1, further comprising: a static image display unit to extract a static image from the picture contained in each reproduction unit and display the extracted static image, and
an operation unit to accept the setting of the weight on the displayed static image,
wherein the weighting unit sets the accepted weight on the data part containing the static image undergoing the acceptance of the weight setting.

8. A program data processing method by which a computer executes:
reading by a processing circuit included in the computer a data part contained in program data from a file stored with program data;
extracting by the processing circuit feature information for distinguishing between reproduction information to be reproduced from the data part and reproduction information to be reproduced from another data part;
acquiring by the processing circuit a weight set on the extracted feature extracted by the extracting information from a weight table storage unit in which to set the weight per feature information contained in the program data; and
allocating by the processing circuit the acquired weight acquired by the acquiring to the data part from which the feature portion is extracted.

9. The program data processing method according to claim 8, the method further comprising:
storing by the processing circuit the weight in the way of being associated with the data part.

10. The program data processing method according to claim 8, the method further comprising:
detecting by the processing circuit a user's operation when reproducing the data part;
incrementing by the processing circuit a weight on the feature information extracted from the data part when a user decreases the reproduction speed during the reproduction of the data part;
decrementing by the processing circuit the weight on the feature information extracted from the data part when increasing the reproduction speed; and
setting by the processing circuit the weight together with the feature information in the weight table storage unit.

11. The program data processing method according to claim 8, the method further comprising:
decrementing by the processing circuit, when the reproduction of at least a portion of the data part is omitted, decrements the weight on the feature information extracted from the data part.

12. The program data processing method according to claim 8, the method further comprising:
extracting by the processing circuit a static image from the picture contained in each reproduction unit,
displaying by the processing circuit the extracted static image extracted by the extracting,
accepting by the processing circuit the setting of the weight on the displayed static image, and
setting by the processing circuit the accepted weight on the data part containing the static image undergoing the acceptance of the weight setting.

13. A non-transitory storage medium storing a program, upon being loaded into a computer, the program for making a computer execute a method, the method comprising:
reading a data part contained in program data from a file stored with program data;
extracting feature information for distinguishing between reproduction information to be reproduced from the data part and reproduction information to be reproduced from another data part;
acquiring a weight set on the feature information extracted by the extracting from a weight table storage unit in which to set the weight per feature information contained in the program data; and
allocating the acquired weight acquired by the acquiring to the data part from which the feature portion is extracted.

14. The storage medium according to claim 13, the program further making the computer execute:
storing the weight in the way of being associated with the data part.

15. The storage medium according to claim 13, the program further making the computer execute:
detecting a user's operation when reproducing the data part;
incrementing a weight on the feature information extracted from the data part when a user decreases the reproduction speed during the reproduction of the data part;
decrementing the weight on the feature information extracted from the data part when increasing the reproduction speed; and
setting the weight together with the feature information in the weight table storage unit.

16. The storage medium according to claim 13, the program further making the computer execute:
decrementing, when the reproduction of at least a portion of the data part is omitted, decrements the weight on the feature information extracted from the data part.

17. The storage medium according to claim 13, the program further making the computer execute:
extracting a static image from the picture contained in each reproduction unit,
displaying the extracted static image extracted by the extracting,
accepting the setting of the weight on the displayed static image, and
setting the accepted weight on the data part containing the static image undergoing the acceptance of the weight setting.
